(19) United States
(12) Patent Application Publication
(10) Pub. No.: US 2009/0257371 A1
(43) Pub. Date: Oct. 15, 2009

(54) RADIO COMMUNICATION BASE STATION APPARATUS AND TRANSMISSION METHOD IN THE RADIO COMMUNICATION BASE STATION APPARATUS

(75) Inventor: Akihiko Nishio, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/298,477

(22) PCT Filed: Apr. 27, 2007
(86) PCT No.: PCT/JP2007/059219

§ 371 Date: Oct. 24, 2008

(30) Foreign Application Priority Data
May 1, 2006 (JP) 2006-127632

(51) Int. Cl. H04H 20/71

(52) U.S. Cl. 370/312

(57) ABSTRACT

Provided is a base station capable of SFN transmission of multicast data by using an empty section of an allocated resource. In this base station, an arrangement unit (109) arranges unicast data, multicast data, control information for downlink line unicast data, control information for uplink line unicast data, and a pilot for unicast data in one of sub-carriers in a plurality of OFDM symbols and outputs them to an IFFT unit (110). The IFFT unit (110) performs IFFT on a plurality of sub-carriers to generate an OFDM symbol. The arrangement unit (109) arranges control information for downlink line unicast data according to an arrangement pattern common to a plurality of cells in a sub-frame where unicast data is arranged and no multicast data is arranged and arranges multicast data according to the same arrangement pattern as the common arrangement pattern in a sub-frame where multicast data is arranged.

### TECHNICAL FIELD

The present invention relates to a transmitting method in a radio communication base station apparatus and radio communication base station apparatus.

### BACKGROUND ART

Recently, in mobile communication, various information such as images and data other than speech are transmission targets. Accompanying this, demands for more reliable and higher speed transmission are increasing. However, when high speed transmission is carried out in mobile communication, the influence of delay waves due to multipath cannot be ignored, and transmission performances degrade due to frequency selective fading.

As one of counter techniques for frequency selective fading, multicarrier communication represented by OFDM (Orthogonal Frequency Division Multiplexing) communication is focused upon. “Multicarrier communication” refers to transmitting data using a plurality of subcarriers where transmission speed is suppressed to such an extent that frequency selective fading does not occur. OFDM communication in particular provides the maximum frequency efficiency in multicarrier communication because the frequencies of a plurality of subcarriers where data is arranged are orthogonal to each other, and enables multicarrier communication with a comparatively simple hardware configuration. For this reason, OFDM communication is focused upon as a communication method to be employed in cellular scheme mobile communication and various studies upon this communication are underway. Further, with OFDM communication, to prevent inter-symbol interference (ISI), the rear portion of an OFDM symbol is added to the head of the OFDM symbol as a cyclic prefix (CP). Consequently, the receiving end is able to prevent ISI as long as the delay time of the delay wave stays within the time length of the CP (hereinafter simply “CP length”).

Further, with OFDM communication, pilots distributed and arranged across the communication band are transmitted to perform channel estimation on a per subcarrier basis. Further, studies are underway to perform hopping of subcarriers to which pilots are allocated on a per subframe basis. When pilots are subjected to hopping, different hopping patterns are used between cells so as to prevent pilots from interfering each other between adjacent cells.

Further, studies are underway to perform frequency scheduling formed with subcarrier allocation and MCS (Modulation and Coding Scheme) assignment to provide multi-user diversity in OFDM communication. Given that the channel quality of each mobile station varies per frequency component in frequency selective fading channels, the base station carries out subcarrier allocation and MCS assignment for each mobile station based on channel quality information fed back from each mobile station. These allocation and assignment are carried out on a per subframe basis for both downlink and uplink. Consequently, the base station that carries out frequency scheduling transmits, on a per subframe basis, downlink allocation information (DL allocation information) and uplink allocation information (UL allocation information) as control information, to each mobile station. Generally, DL allocation information and UL allocation information are transmitted at the head of a subframe prior to transmitting data.

Further, studies related to multicast communication are underway. Multicast communication is not one-to-one communication as in unicast communication but is one-to-many communication. That is, with multicast communication, one base station transmits the same data, at the same time, to a plurality of mobile stations. By this multicast communication, in mobile communication systems, for example, distribution services of music data and video image data and broadcast services such as television broadcast are realized. Further, services using multicast communication are assumed to be services for relatively wide communication areas that cannot be covered by one base station, and, consequently, multicast communication entirely covers wide communication areas by transmitting the same data from a plurality of base stations. That is, multicast data is the same between a plurality of cells. Thus, in the multicast communication, the same multicast data is transmitted from a plurality of base stations at the same time, and, consequently, a mobile station nearby the cell boundary receives mixed multicast data comprised of multiple multicast data from a plurality of base stations.

Here, if the OFDM scheme is employed in multicast communication and there is a mobile station located nearby the cell boundary, if a plurality of the same OFDM symbols transmitted at the same time from a plurality of base stations with a shorter time lag than the CP length, these OFDM symbols are combined and received in a state their received power is amplified. The method of transmitting the same data from a plurality of base stations using the same resources, (at the same time, by the same frequency) in this way will be referred to as “SFN (Single Frequency Network) transmission.” In SFN transmission, the mobile station is able to receive data without inter-cell interference, so that high quality transmission of a low error rate is possible. Further, a channel estimation value of the combined signal is required to compensate the channel variation (i.e. phase variation and amplitude variation) of such a combined signal by channel estimation. Accordingly, in multicast communication utilizing the OFDM scheme, as to the multicast data pilot used to determine the channel estimation value, the same pilot needs to be transmitted from a plurality of base stations at the same time as in multicast data. That is, the multicast data pilot needs to be a common pilot between a plurality of cells.

On the other hand, in unicast communication, a plurality of base stations transmit varying unicast data (see Non-Patent Document 1). That is, unicast data varies between a plurality of cells. Accordingly, in unicast communication, as to the pilot used to determine the channel estimation value, the varying unicast data pilot needs to be transmitted from a plurality of base stations as in unicast data. That is, the unicast data pilot needs to vary between a plurality of cells.

Further, recently, studies are underway to time-domain-multiplex multicast data and unicast data in subframe units (see Non-Patent Document 2). Furthermore, studies are underway to time-domain-multiplex unicast data control information such as DL allocation information and UL allocation information and multicast data in the same subframe (see Non-Patent Document 3).

While multicast communication employs a form of communication of transmitting information only to specific mobile stations joined in a service such as a news group, broadcast communication employs a form of communication of transmitting information to all mobile stations as in today's television broadcasting and radio broadcasting. However, multicast and broadcast share in common transmitting the same data at the same time from a base station to a plurality of mobile stations. Therefore, there are references that disclose use of MBMS (Multimedia Broadcast/Multicast Service) that combines multicast and broadcast. Further, there are other references that disclose use of broadcast instead of multicast.

Non-Patent Document 1: “Pilot channel and scrambling code in evolved UTRA downlink,” 3GPP TSG RAN WG1 LTE Ad Hoc Meeting (2005.06) R1-050589
Non-Patent Document 2: “MBMS Channel Structure for E-UTRA Downlink,” 3GPP RAN WG1#44bis meeting (2006.03) R1-060778
Non-Patent Document 3: “Multiplexing of multi-cell MBMS and unicast transmission,” 3GPP RAN WG1#44bis meeting (2006.03) R1-060917

### DISCLOSURE OF INVENTION

### Problems to be Solved by the Invention

A case will be described here where radio communication that combines the above techniques is carried out in the mobile communication system. That is, unicast communication and multicast communication are carried out according to the OFDM scheme, and multicast data and unicast data are time-domain-multiplexed in subframe units. Further, frequency scheduling of unicast data is carried out, and unicast data control information such as DL allocation information and UL allocation information, and multicast data, are time-domain-multiplexed in the same subframe. Further, unicast data control information is transmitted with a pilot in the head of the subframe. Furthermore, the subcarriers to which the pilot is allocated are subjected to hopping per subframe according to hopping patterns that vary between the cells.

In this case, for example, the signal arrangement in cell A is as shown in FIG. 1, and the signal arrangement in cell B adjacent to cell A is as shown in FIG. 2. In FIG. 1 and FIG. 2, “C_{DL}” is downlink unicast data control information such as DL allocation information, “C_{UL}” is uplink unicast data control information such as UL allocation information, “PLᵤ” is the unicast data pilot, “u” is unicast data and “m” is multicast data. Further, one OFDM symbol is formed with subcarriers f₁ to f₁₆, and one subframe is formed with OFDM symbols #1 to #8. As shown in FIG. 1 and FIG. 2, in the head OFDM symbols (i.e. OFDM symbol #1) in subframes #1 and #3 formed with unicast data, PLᵤ, C_{DL} and C_{UL} are transmitted.

On the other hand, subframe #2, formed with multicast data, is not allocated downlink unicast data and therefore does not require C_{DL}. In this way, in the head OFDM symbol (i.e. OFDM symbol #1) of subframe #2, only P_{LU} and C_{UL} are transmitted, a void of resource allocation is produced in subcarriers corresponding to the number of C_{DL} which are not necessary to be transmitted. For example, a void of resource allocation is produced in subcarriers f₁, f₅, f₉ and f₁₃ in OFDM symbol #1 in subframe #2 in cell A (FIG. 1), and a void of resource allocation is produced in subcarriers f₃, f₇, f₁₁ and f₁₅ in OFDM symbol #1 in subframe #2 in cell B (FIG. 2).

Consequently, it is possible to allocate multicast data to these subcarriers in which a void resource allocation is produced in subframe #2.

However, given that hopping of PLᵤ is possible in all subcarriers f₁ to f₁₆ and the hopping pattern for PLᵤ varies between cells, the subcarriers in which a void of resource allocation is produced in cell #1 (FIG. 1) are likely to be different from the subcarriers in which a void of resource allocation is produced in cell #2 (FIG. 2) Therefore, even if multicast data is allocated to these subcarriers, SFN transmission of multicast data is not possible, but allocating additional multicast data produces inter-cell interference and degrades received performances in mobile stations.

It is therefore an object of the present invention to provide a transmitting method in a radio communication base station apparatus and radio communication base station apparatus that enables SFN transmission of multicast data using void of resource allocation and improves the received performances of multicast data in mobile stations.

### Means for Solving the Problem

The radio communication base station apparatus according to the present invention employs a configuration including: an arranging section that, in a first subframe in which unicast data is arranged and multicast data is not arranged, arranges downlink unicast data control information according to an arrangement pattern that is common between a plurality of cells, and arranges a unicast data pilot according to an arrangement pattern that is different from the common arrangement pattern and that varies between the plurality of cells, and, in a second subframe in which the multicast data is arranged, arranges the multicast data or a multicast data pilot according to a same arrangement pattern as the common arrangement pattern; and a transmitting section that transmits the downlink unicast data control information and the unicast data pilot arranged in the first subframe and the multicast data or the multicast data pilot arranged in the second subframe.

### ADVANTAGEOUS EFFECT OF THE INVENTION

The present invention enables SFN transmission of multicast data using void of resource allocation and improves the received performances of multicast data in mobile stations.

### BRIEF DESCRIPTION OF DRAWINGS

FIG. 1 shows a signal arrangement example (cell A);

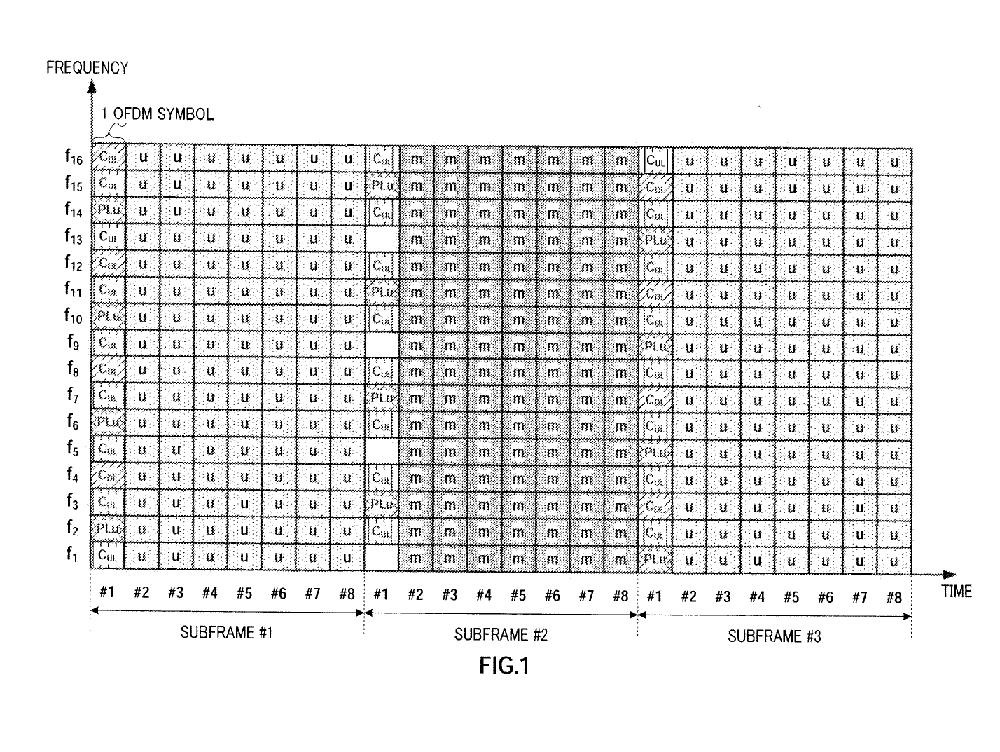

FIG. 2 shows a signal arrangement example (cell B);

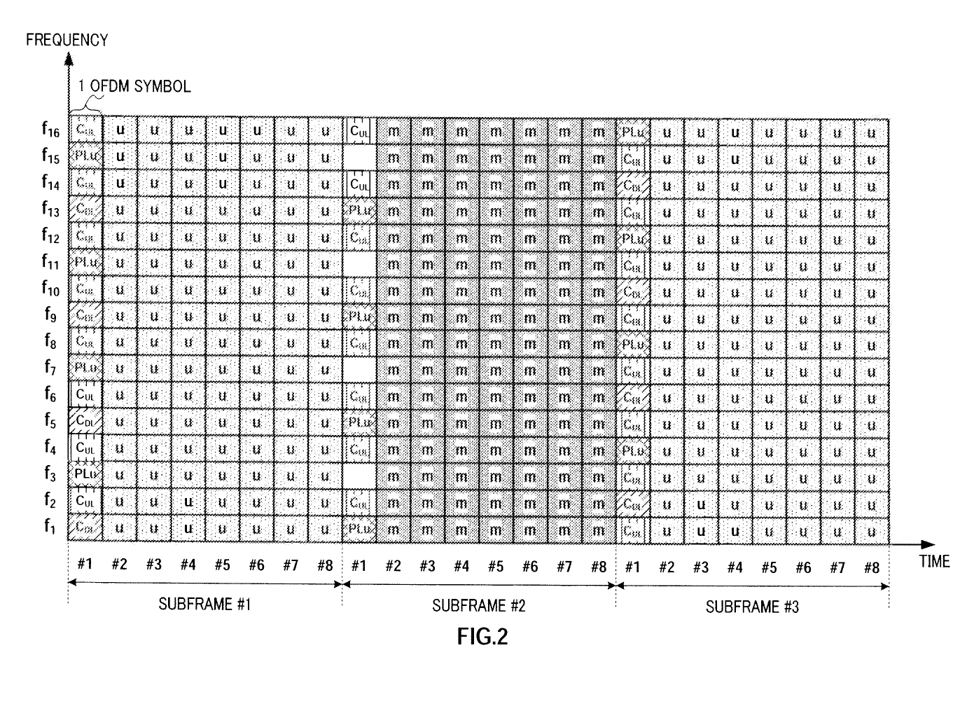

FIG. 3 is a block diagram showing a configuration of the base station according to an embodiment of the present invention;

FIG. 4 shows signal arrangement example 1 according to an embodiment of the present invention (cell A);

FIG. 5 shows signal arrangement example 1 according to an embodiment of the present invention (cell B);

FIG. 6 shows signal arrangement example 2 according to an embodiment of the present invention (cell A);

FIG. 7 shows signal arrangement example 2 according to an embodiment of the present invention (cell B);

FIG. 8 shows signal arrangement example 3 according to an embodiment of the present invention (cell A);

FIG. 9 shows signal arrangement example 3 according to an embodiment of the present invention (cell B);

FIG. 10 shows signal arrangement example 4 according to an embodiment of the present invention (cell A);

FIG. 11 shows signal arrangement example 4 according to an embodiment of the present invention (cell B);

FIG. 12 shows signal arrangement example 5 according to an embodiment of the present invention (cell A); and

FIG. 13 shows signal arrangement example 5 according to an embodiment of the present invention (cell B).

### BEST MODE FOR CARRYING OUT THE INVENTION

Hereinafter, an embodiment of the present invention will be described in detail with reference to the drawings. Although the OFDM scheme will be described as an example of the multicarrier communication scheme in the following description, the present invention is not limited to the OFDM scheme.

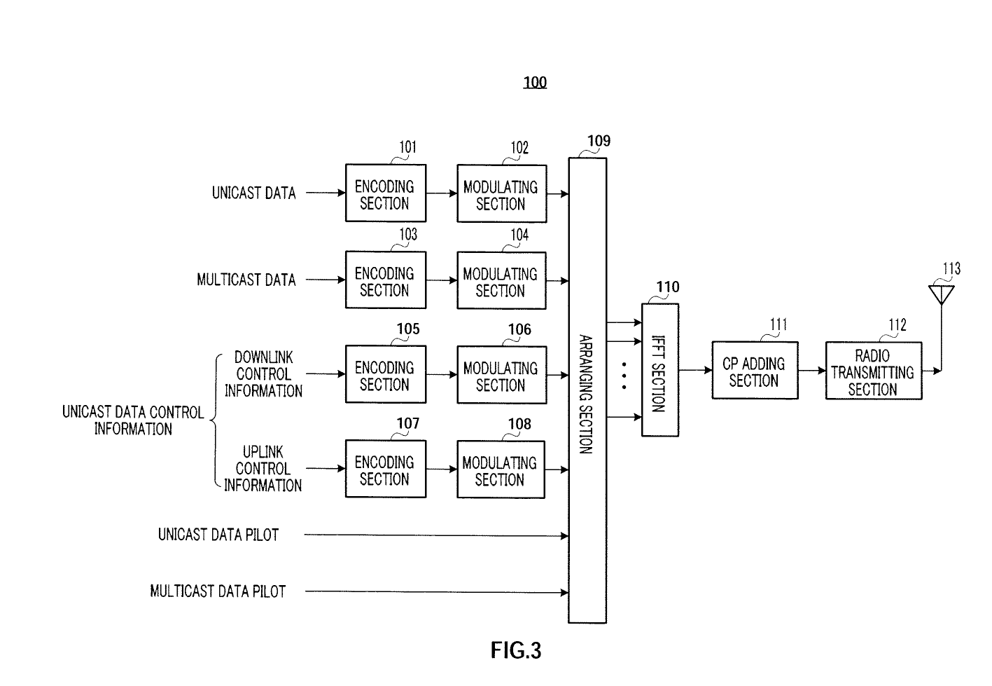

FIG. 3 shows a configuration of base station 100 according to the present embodiment.

Encoding section 101 encodes unicast data and outputs the result to modulating section 102.

Modulating section 102 modulates the encoded unicast data and outputs the result to arranging section 109.

Encoding section 103 encodes multicast data and outputs the result to modulating section 104.

Modulating section 104 modulates the encoded multicast data and outputs the result to arranging section 109.

Encoding section 105 encodes downlink unicast data control information such as DL allocation information in unicast data control information, and outputs the result to modulating section 106.

Modulating section 106 modulates the encoded downlink unicast data control information and outputs the result to arranging section 109.

Encoding section 107 encodes uplink unicast data control information such as UL allocation information in unicast data control information, and outputs the result to modulating section 108.

Modulating section 108 modulates the encoded uplink unicast data control information and outputs the result to arranging section 109.

Further, arranging section 109 receives the unicast data pilot and multicast data pilot as input.

Arranging section 109 arranges unicast data, multicast data, downlink unicast data control information, uplink unicast data control information, the unicast data pilot and multicast data pilot at locations on a two-dimensional plane representing the frequency domain and the time domain, and outputs the data and information to IFFT (Inverse Fast Fourier Transform) section 110. The frequency domain corresponds to a plurality of subcarriers forming one OFDM symbol, and the time domain corresponds to a plurality of OFDM symbols that are sequentially transmitted. That is, arranging section 109 arranges unicast data, multicast data, downlink unicast data control information, uplink unicast data control information, the unicast data pilot and multicast data pilot to a plurality of subcarriers in a plurality of OFDM symbols.

IFFT section 110 carries out an IFFT of a plurality of subcarriers in which unicast data, multicast data, downlink unicast data control information, uplink unicast data control information, the unicast data pilot and multicast data pilot are arranged, into time domain signals, to generate OFDM symbols which are multicarrier signals.

CP adding section 111 adds the same signal as the rear portion of an OFDM symbol to the head of an OFDM symbol as CP.

Radio transmitting section 112 carries out transmission processing such as D/A conversion, amplification and up-conversion of OFDM symbols after CP's are added and transmits the result from antenna 113.

Next, details of arrangement processing in arranging section 109 will be described referring to some arrangement examples.

In the following description, downlink unicast data control information is “C_{DL},” uplink unicast data control information is “C_{UL},” the unicast data pilot is “PLᵤ,” the multicast data pilot is “PLₘ,” unicast data is “u” and multicast data is “m.” Further, one OFDM symbol is formed with subcarriers f₁ to f₁₆, and one subframe is formed with OFDM symbols #1 to #8. Further, the base station in cell A and the base station in cell B both employ the configuration shown in FIG. 3. Further, cell A and cell B are adjacent to each other.

In the following arrangement examples, in subframes #1 and #3 in which unicast data (u) is arranged and multicast data (m) is not arranged, arranging section 109 arranges downlink unicast data control information (C_{DL}) according to an arrangement pattern that is common between a plurality of cells and arranges the unicast data pilot (PLᵤ) according to an arrangement pattern that is different from the common arrangement pattern and that varies between a plurality of cells, and, on the other hand, in subframe #2 in which multicast data (m) is arranged, arranges multicast data (m) or the multicast data pilot (PLₘ) according to the same arrangement pattern as the common arrangement pattern.

That is, arranging section 109 makes the arrangement pattern for downlink unicast data control information (C_{DL}) and the arrangement pattern for multicast data (m) or the multicast data pilot (PLₘ) the same between different subframes and makes these arrangement patterns the same between a plurality of cells. Further, in a subframe in which downlink unicast data control information (C_{DL}) is arranged, arranging section 109 arranges the unicast data pilot (PLᵤ) to locations other than locations in which downlink unicast data control information (C_{DL}) is arranged, and makes the arrangement patterns for the unicast data pilot (PLᵤ) different between a plurality of cells.

By this means, when downlink unicast data control information (C_{DL}) needs not to be transmitted, multicast data (m) or the multicast data pilot (PLₘ) that is arranged instead of downlink unicast data control information (C_{DL}) is transmitted using the same resources (at the same time, by the same frequency), so that it is possible to carry out SFN transmission of multicast data (m) or the multicast data pilot (PLₘ) using void of resource allocation for downlink unicast data control information (C_{DL}). Consequently, it is possible to improve the received performances of multicast data (m) or the multicast data pilot (PLₘ) in mobile stations.

Further, more preferably, arranging section 109 changes the arrangement pattern for the unicast data pilot (PLᵤ) on a per subframe basis. The mobile stations determine channel estimation values of all subcarriers by carrying out interpolation processing between pilots that are distributed and arranged across the communication band. Consequently, the accuracy of channel estimation for subcarriers close to the subcarriers in which the pilot is arranged is high, and the accuracy of channel estimation for subcarriers apart from the subcarriers in which the pilot is arranged is low. Then, to make the accuracy of channel estimation for each subcarrier uniform between subcarriers, it is preferable to change the arrangement pattern for the unicast data pilot (PLᵤ) on a per subframe basis.

Further, more preferably, arranging section 109 makes the arrangement pattern for downlink unicast data control information (C_{DL}) that is common between a plurality of cells the same between all subframes. By this means, when the arrangement pattern for the unicast data pilot (PLᵤ) is set to vary between cells and subframes, the change of the arrangement pattern for downlink unicast data control information (C_{DL}) needs not to be taken into account, so that it is easy to set the arrangement pattern for the unicast data pilot (PLᵤ).

Hereinafter, arrangement examples 1 to 5 will be described.

### Arrangement Example 1

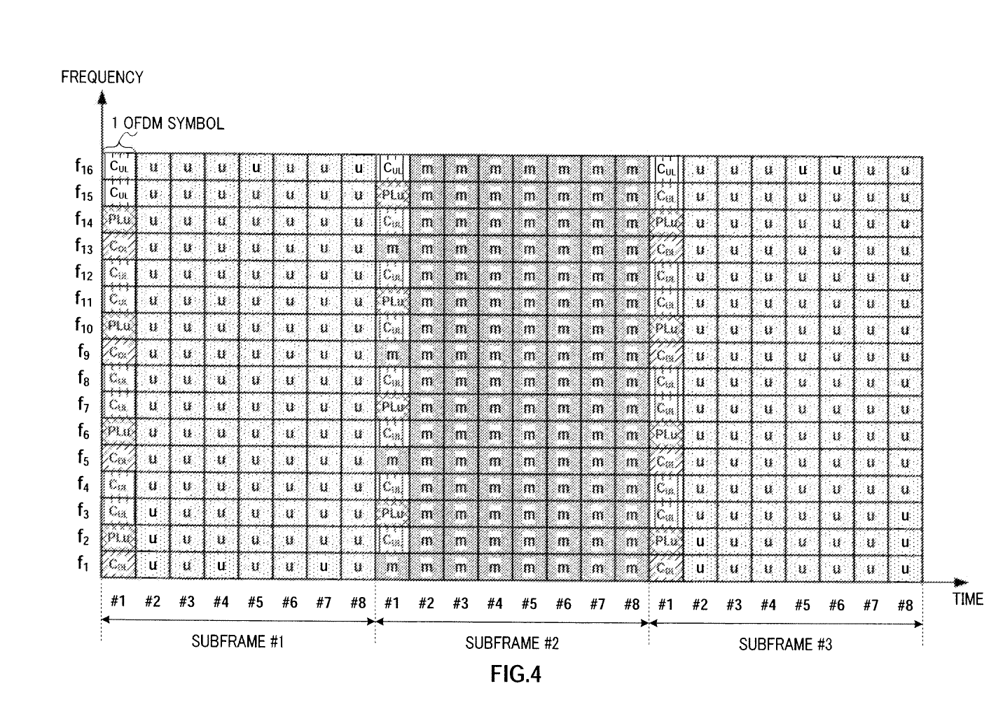

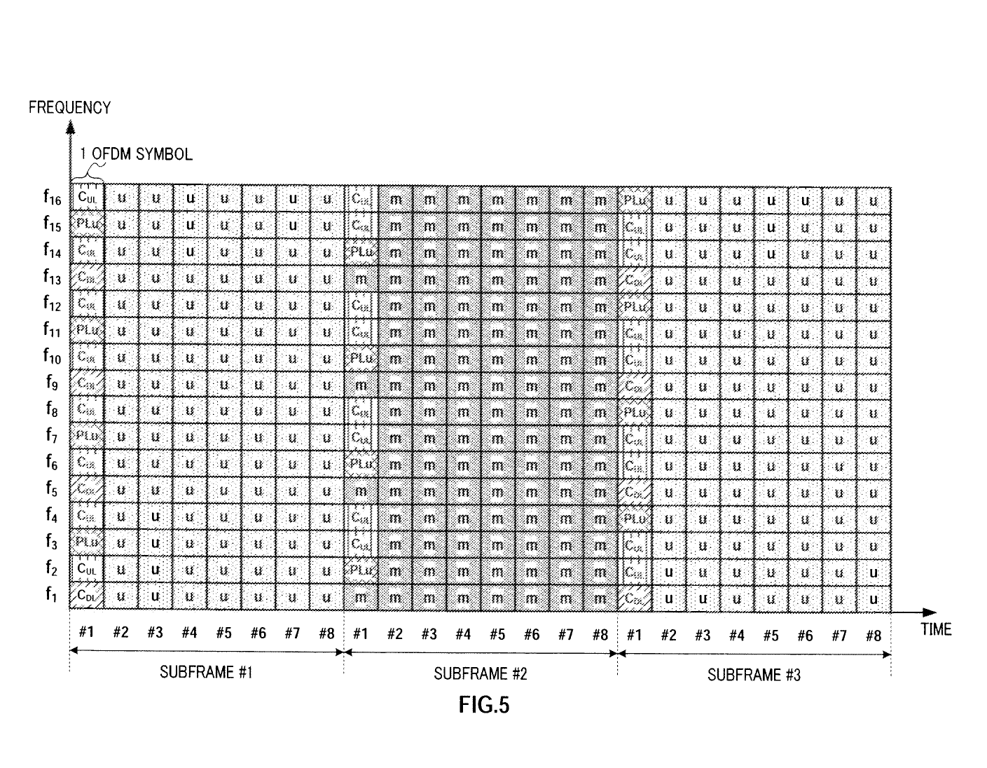

### FIG. 4: Cell A and FIG. 5: Cell B

With the present arrangement example, as shown in FIG. 4 and FIG. 5, the base station in cell A and the base station in cell B arrange PLᵤ, C_{DL} and C_{UL} in OFDM symbol #1 (i.e. head OFDM symbol) in subframes #1 and #3, in which u is arranged and m is not arranged. In this case, the arrangement pattern for C_{DL} is made the same between cell A and cell B and between subframes #1 and #3. To be more specific, C_{DL} is arranged to subcarriers f₁, f₅, f₉ and f₁₃ in OFDM symbol #1 in subframes #1 and #3 both in cell A and cell B.

Further, given that subframe #2, in which m is arranged and u is not arranged, does not require C_{DL}, the base station in cell A and the base station in cell B arrange m instead of C_{DL} to subcarriers f₁, f₅, f₉ and f₁₃ in OFDM symbol #1. That is, the base station in cell A and the base station B arrange m instead of C_{DL} in subframe #2 according to the same arrangement pattern as the arrangement pattern for C_{DL} in subframe #1. Consequently, the arrangement patterns for all m including m arranged instead of C_{DL}, are made the same between cell A and cell B, so that it is possible to transmit all m at the same time, by the same frequency, to mobile stations both in cell A and cell B.

Further, the base station in cell A and the base station in cell B arrange PLᵤ and C_{UL} to subcarriers f₂ to f₄, f₆ to f₈, f₁₀ to f₁₂ and f₁₄ to f₁₆ other than subcarriers f₁, f₅, f₉ and f₁₃, in which C_{DL} or m is arranged in OFDM symbol #1 in subframes #1 to #3. Further, the base station in cell A and the base station in cell B change the subcarriers in which PLᵤ is arranged in OFDM symbol #1 on a per subframe basis, to perform hopping of PLᵤ in the frequency domain. In this case, the hopping pattern for PLᵤ is made to vary between cell A and cell B. That is, the arrangement pattern for PLᵤ in the same subframes is made to vary between cell A and cell B, and the arrangement pattern for PLᵤ is made to vary between subframes #1, and #2 and #3.

In this way, according to the present arrangement example, it is possible to carry out SFN transmission of m using void of resource allocation for C_{DL}.

### Arrangement Example 2

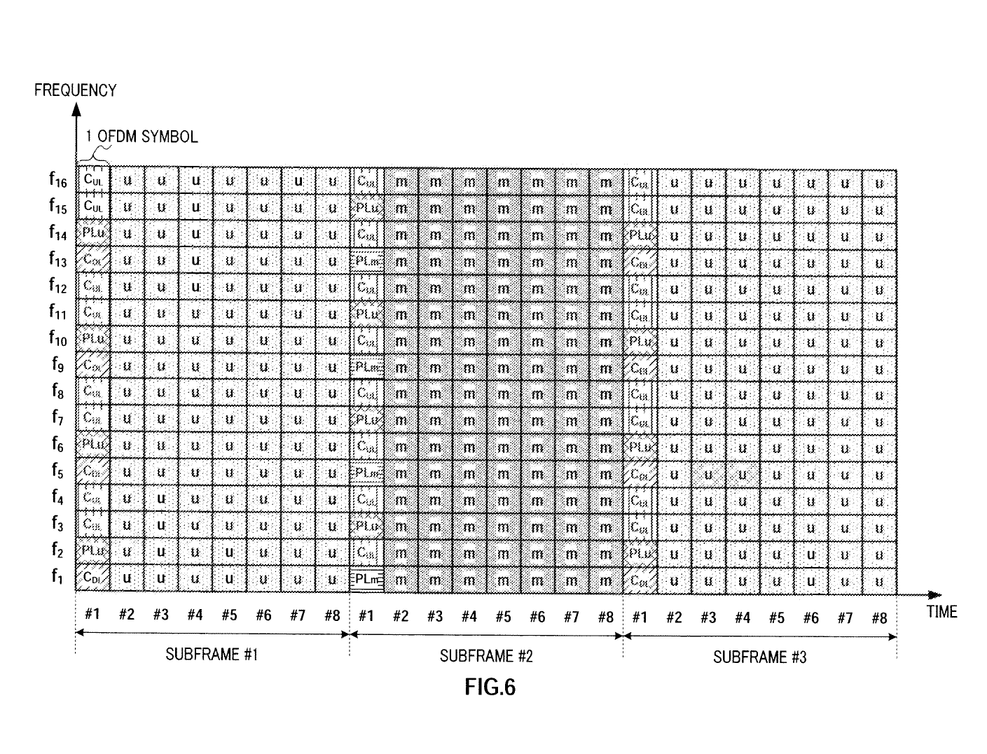

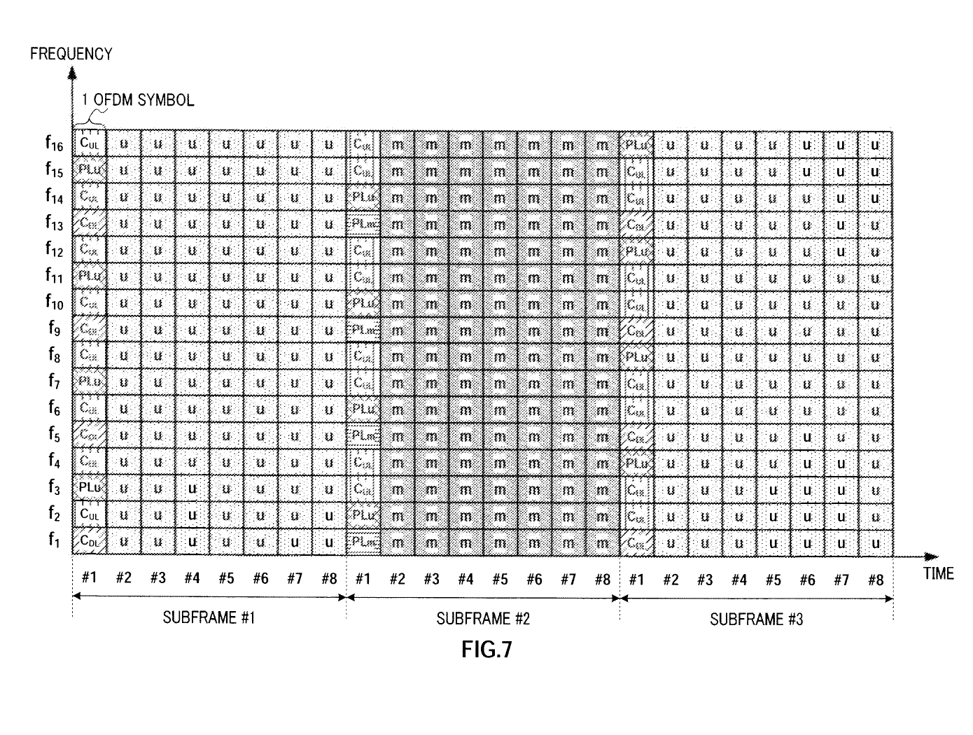

### FIG. 6: Cell A and FIG. 7: Cell B

As shown in FIG. 6 and FIG. 7, the present arrangement example and arrangement example 1 are the same except that PLₘ is arranged in subcarriers f₁, f₅, f₉ and f₁₃ in OFDM symbol #1 in subframe #2.

By this means, according to the present arrangement example, it is possible to carry out SFN transmission of PLₘ using void of resource allocation for C_{DL}. Further, PLₘ can be arranged in locations in which PLᵤ cannot be arranged in adjacent cells, so that it is possible to prevent pilots in the adjacent cells from interfering PLₘ at the edge of a cell group in which SFN transmission is carried out.

### Arrangement Example 3

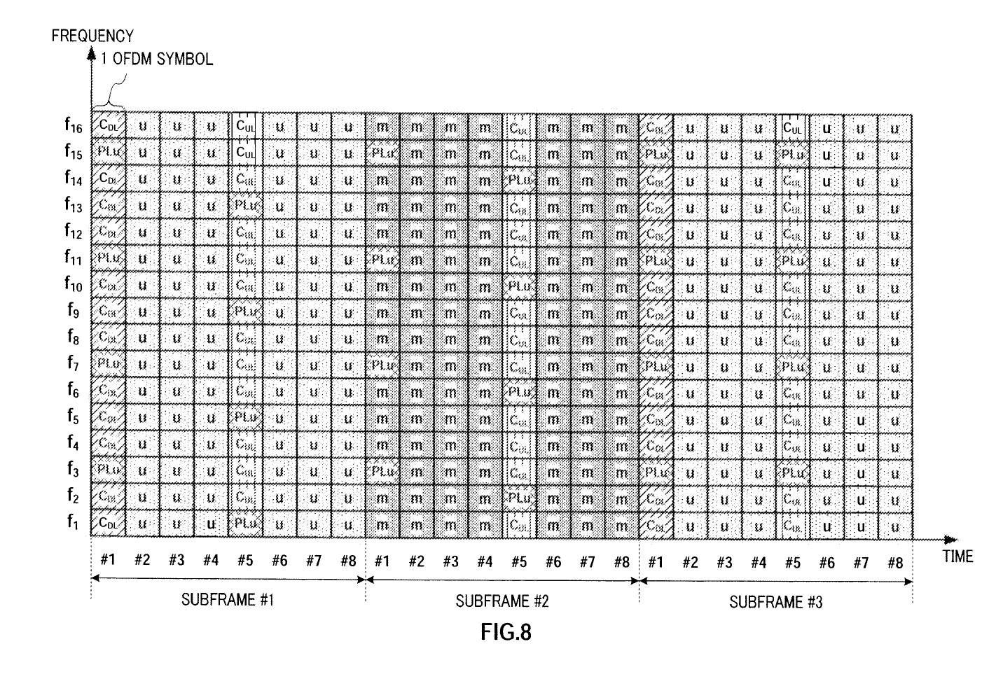

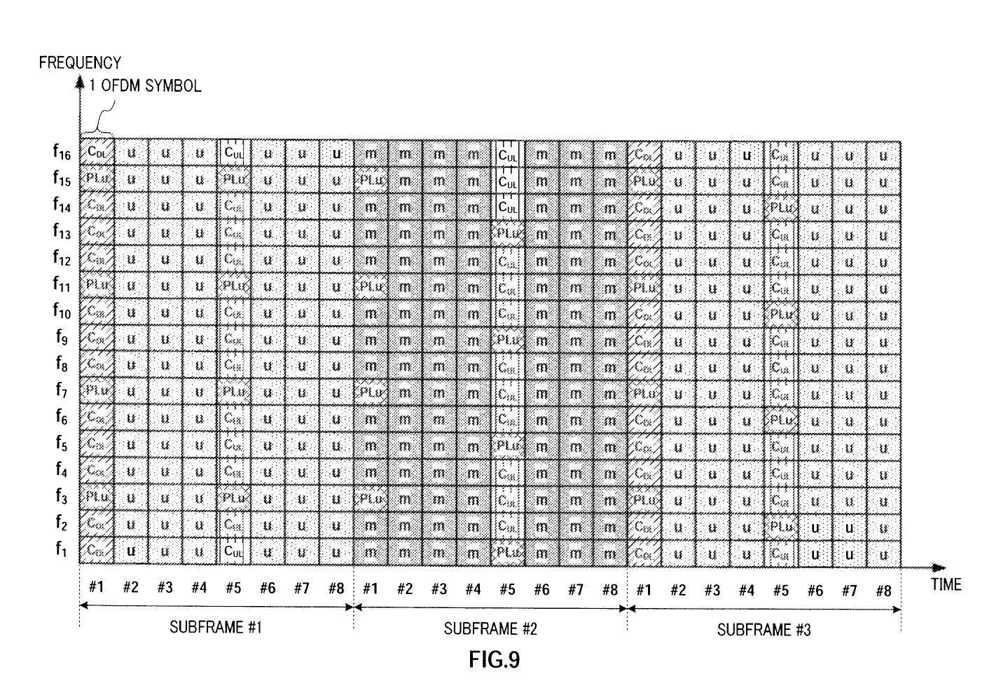

### FIG. 8: Cell A and FIG. 9: Cell B

With the present arrangement example, as shown in FIG. 8 and FIG. 9, the base station in cell A and the base station in cell B arrange PLᵤ and C_{DL} in OFDM symbol #1 (i.e. head OFDM symbol) in subframes #1 and #3, in which u is arranged and m is not arranged. In this case, the arrangement pattern for C_{DL} is made the same between cell A and cell B and between subframes #1 and #3. To be more specific, C_{DL} is arranged in subcarriers f₁, f₂, f₄ to f₆, f₈ to f₁₀, f₁₂ to f₁₄ and f₁₆ in OFDM symbol #1 in subframes #1 and #3 both in cell A and cell B.

Further, given that subframe #2, in which m is arranged and u is not arranged, does not require C_{DL}, the base station in cell A and the base station in cell B arrange m instead of C_{DL} in subcarriers f₁, f₂, f₄ to f₆, f₈ to f₁₀, f₁₂ to f₁₄ and f₁₆ in OFDM symbol #1. That is, the base station in cell A and the base station in cell B arrange m instead of C_{DL} in subframe #2 according to the same arrangement pattern as the arrangement pattern for C_{DL} in subframe #1. By this means, the arrangement patterns for all m including m arranged instead of C_{DL}, are made the same between cell A and cell B, so that it is possible to transmit all m at the same time, by the same frequency, to mobile stations both in cell A and cell B.

Further, the base station in cell A and the base station in cell B arrange PLᵤ in subcarrier f₃, f₇, f₁₁ and f₁₅ other than f₁, f₂, f₄ to f₆, f₈ to f₁₀, f₁₂ to f₁₄ and f₁₆ in which C_{DL} or m is arranged, in OFDM symbol #1 in subframes #1 to #3. In this way, with the present arrangement example, the subcarriers in which PLᵤ is arranged in OFDM symbol #1 are made the same between subframes #1, #2 and #3.

Further, the base station in cell A and the base station in cell B arrange PLᵤ and C_{UL} in OFDM symbol #5 in subframes #1 to #3. In this case, the base station in cell A and the base station in cell B make the subcarriers in which PLᵤ is arranged in OFDM symbol #1 the same between subframes #1, #2 and #3, but changes the subcarriers in which PLᵤ is arranged in OFDM symbol #5, on a per subframe basis, to perform hopping of PLᵤ in the frequency domain. Further, the hopping pattern for PLᵤ is made to vary between cell A and cell B. By so doing, it is also possible to make the arrangement pattern for PLᵤ in the same subframes vary between cell A and cell B and make the arrangement pattern for PLᵤ vary between subframes #1, #2 and #3.

In this way, according to the present arrangement example, it is possible to carry out SFN transmission of m using void of resource allocation for C_{DL}. Further, with the present arrangement example, PLᵤ is transmitted using OFDM symbols #1 and #5 of each subframe, that is, PLᵤ is transmitted a plurality of times at different times in one subframe, so that it is possible to improve the accuracy of interpolation for PLᵤ in the time domain. Further, arrangement locations of PLᵤ in OFDM symbol #1 (i.e. head OFDM symbol) are made the same between subframes #1, #2 and #3 and fixed, so that, when mobile stations carry out cell search, mobile stations are able to detect PLᵤ required for cell search at ease.

### Arrangement Example 4

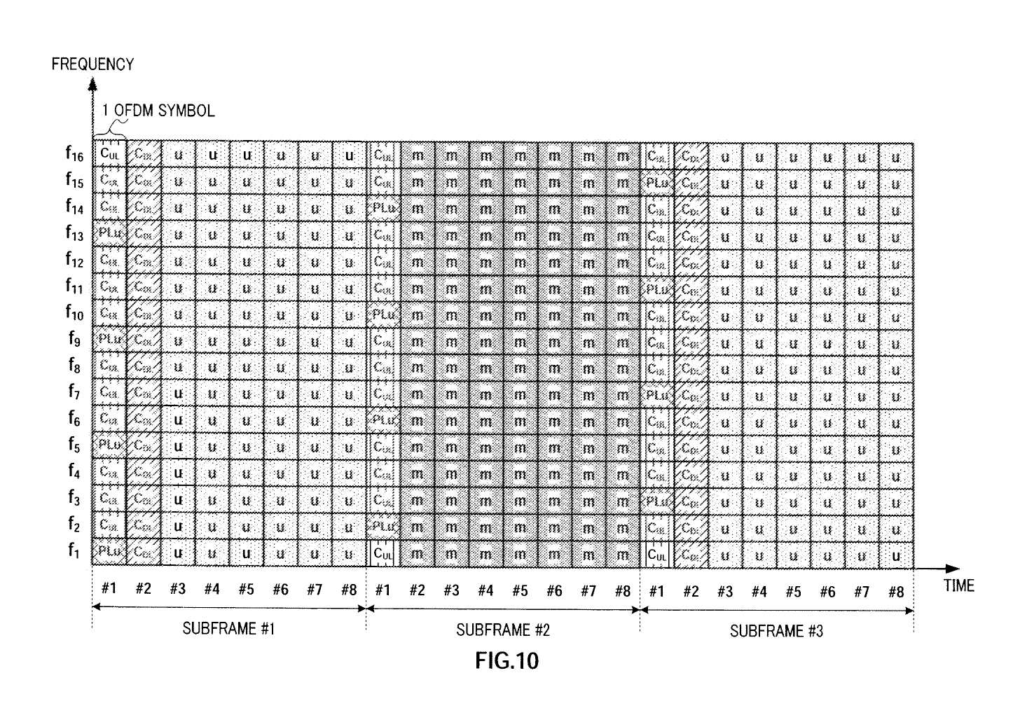

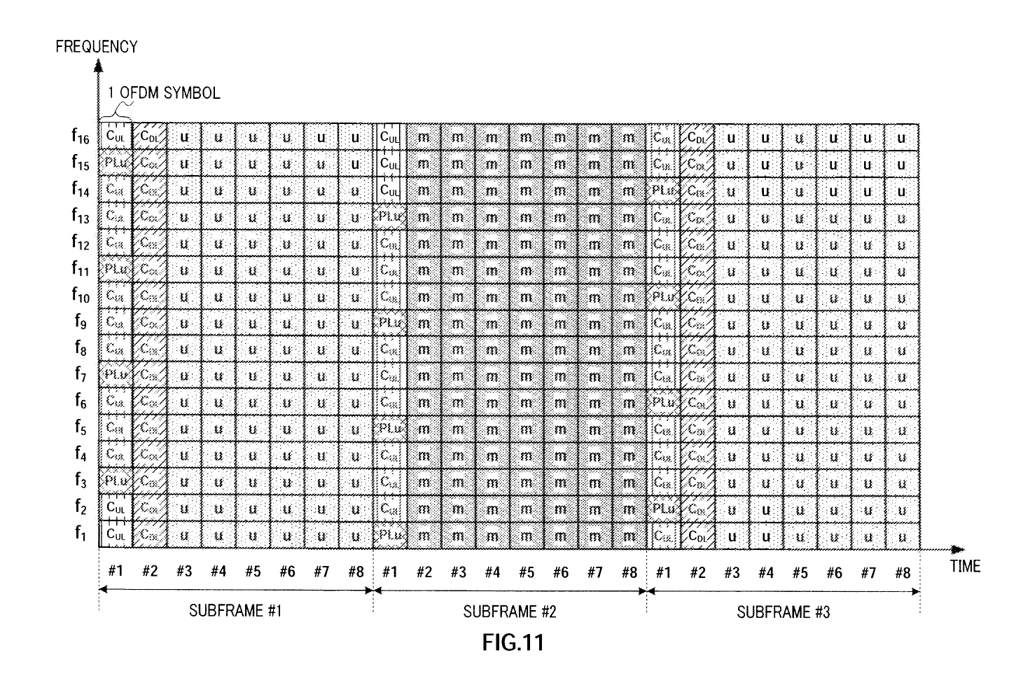

### FIG. 10: Cell A and FIG. 11: Cell B

A case will be described with the present arrangement example where the amount of C_{DL} is great and C_{DL} is transmitted using all subcarriers in one OFDM symbol.

With the present arrangement example, as shown in FIG. 10 and FIG. 11, the base station in cell A and the base station in cell B arrange C_{DL} in OFDM symbol #2 in subframes #1 and #3 in which u is arranged and m is not arranged. In this case, the arrangement pattern for C_{DL} is made the same between cell A and cell B and between subframes #1 and #3. To be more specific, C_{DL} is arranged in all subcarriers in OFDM symbol #2 in subframes #1 and #3 both in cell A and cell B.

Further, given that subframe #2, in which m is arranged and u is not arranged, does not require C_{DL}, the base station in cell A and the base station in cell B arrange m instead of C_{DL} in all subcarriers in OFDM symbol #2. That is, the base station in cell A and the base station in cell B arrange m instead of C_{DL} in subframe #2 according to the same arrangement pattern as the arrangement pattern for C_{DL} in subframe #1. By this means, the arrangement patterns for all m including m arranged instead of C_{DL}, are made the same between cell A and cell B, so that it is possible to transmit all m at the same time, by the same frequency, to mobile stations both in cell A and cell B.

Further, the base station in cell A and the base station in cell B arrange PLᵤ and C_{UL} in OFDM symbol #1 in subframes #1 to #3. In this case, the base station in cell A and the base station in cell B change subcarriers in which PLᵤ is arranged in OFDM symbol #1 on a per subframe basis to perform hopping of PLᵤ in the frequency domain. Further, the hopping pattern for PLᵤ is made to vary between cell A and cell B. That is, the arrangement pattern for PLᵤ in the same subframes is made to vary between cell A and cell B, and the arrangement pattern for PLᵤ is made to vary between subframes #1, #2 and #3.

In this way, according to the present arrangement example, it is possible to carry out SFN transmission of m using void of resource allocation for C_{DL} even when the amount of C_{DL} is great.

### Arrangement Example 5

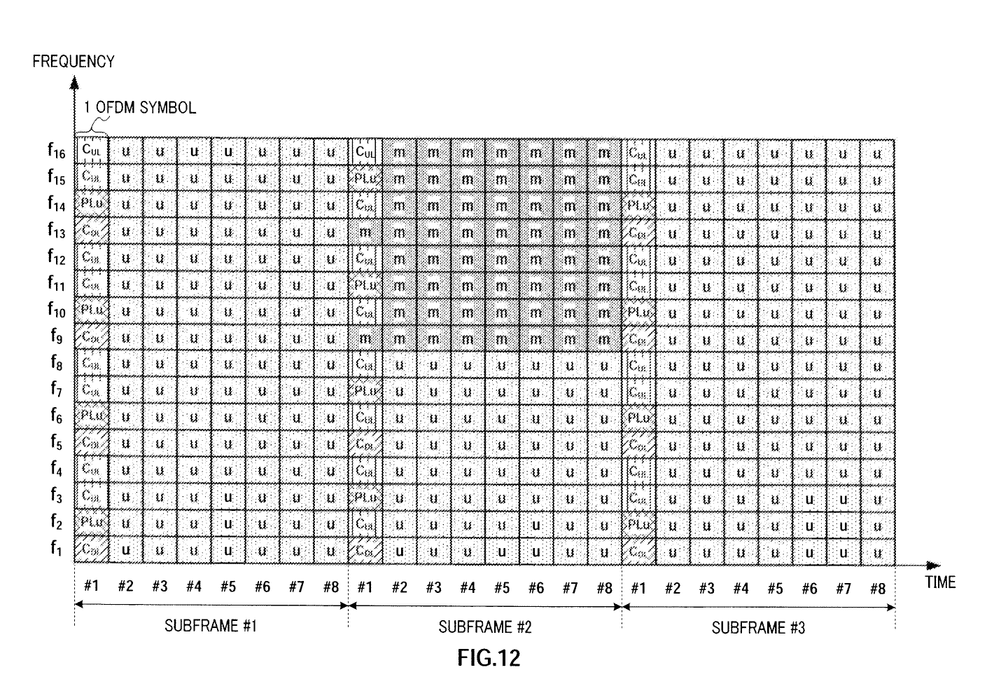

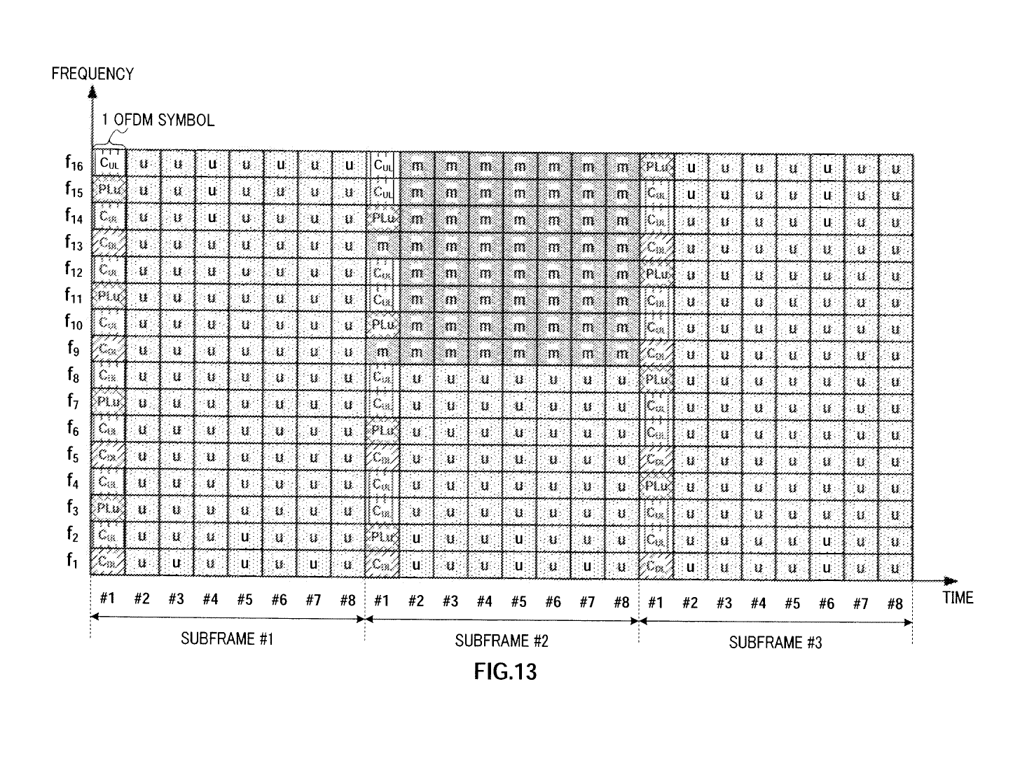

### FIG. 12: Cell A and FIG. 13: Cell B

A case will be described with the present arrangement example where the amount of u is great and m and u are frequency-domain-multiplexed in one subframe. That is, with the present arrangement example, there are subframes in which u is arranged and m is not arranged and subframes in which both u and m are arranged. Consequently, in arrangement examples 1 to 5, there are also subframes in which u is arranged and m is not arranged and subframes in which m are arranged.

With the present arrangement example, as shown in FIG. 12 and FIG. 13, the base station in cell A and the base station in cell B arrange PLᵤ, C_{DL} and C_{UL} in OFDM symbol #1 (i.e. head OFDM symbol) in subframes #1 and #3 in which u is arranged and m is not arranged. In this case, the arrangement pattern for C_{DL} is made the same between cell A and cell B and between subframes #1 and #3. To be more specific, C_{DL} is arranged in subcarriers f₁, f₅, f₉ and f₁₃ in OFDM symbol #1 in subframes #1 and #3 both in cell A and cell B.

Further, given that subframe #2, in which u and m are multiplexed in the frequency domain and both u and m are arranged, does not require C_{DL} in the frequency band in which m is arranged, and requires C_{DL} in the frequency band in which u is arranged, m is arranged instead of C_{DL} only in the frequency band in which m is arranged. That is, the base station in cell A and the base station in cell B arrange m instead of C_{DL} only in subcarriers f₉ to f₁₆ in which m is arranged in subcarriers f₁ to f₁₆. To be more specific, the base station in cell A and the base station in cell B arrange m instead of C_{DL} in subcarriers f₉ and f₁₃ in OFDM symbol #1 in subframe #2. That is, the base station in cell A and the base station in cell B arrange m instead of C_{DL} only in the frequency band in which m is arranged in subframe #2 according to the same arrangement pattern as the arrangement pattern for C_{DL} in subframe #1. By this means, even when m and u are frequency-domain-multiplexed in one subframe, the arrangement patterns for all m including m arranged instead of C_{DL}, are made the same between cell A and cell B, so that it is possible to transmit all m at the same time, by the same frequency, to mobile stations both in cell A and cell B.

Further, the base station in cell A and the base station in cell B arrange PLᵤ and C_{UL} in subcarriers f₂ to f₄, f₆ to f₈, f₁₀ to f₁₂ and f₁₄ to f₁₆ other than subcarriers f₁, f₅, f₉ and f₁₃ in which C_{DL} or m is arranged, in OFDM symbol #1, in subframes #1 to #3. Further, the base station in cell A and the base station in cell B change the subcarriers in which PLᵤ is arranged in OFDM symbol #1 on a per subframe basis, to perform hopping of PLᵤ in the frequency domain. In this case, the hopping pattern for PLᵤ is made to vary between cell A and cell B. That is, the arrangement pattern for PLᵤ in the same subframes is made to vary between cell A and cell B, and the arrangement pattern for PLᵤ is made to vary between subframes #1, #2 and #3.

In this way, according to the present arrangement example, it is possible to carry out SFN transmission of m using void of resource allocation for C_{DL} even when the amount of u is great and there are subframes in which m and u are frequency-domain-multiplexed.

Arrangement examples 1 to 5 have been described.

Further, similar to arrangement example 2, in arrangement examples 3 to 5, PLₘ may be arranged instead of C_{DL} without arranging m instead of C_{DL} in subframe #2. Furthermore, in a subframe in which u is arranged and m is not arranged, for example, BCH (Broadcast channel) information and PCH (Paging Channel) information may be arranged instead of C_{DL} once in one frame (in one subframe, in one frame). By this means, it is possible to carry out SFN transmission of BCH information and PCH information.

Further, transmission timing control information or ACK/NACK signals used in ARQ may be transmitted as control information in addition to DL allocation information and UL allocation information. In this case, in a subframe in which m is arranged and u is not arranged, only information and data related to uplink transmission are transmitted.

Further, by reading “multicast” used in the above description for “broadcast,” the present invention can be implemented as described above in a mobile communication system in which broadcast data and unicast data are multiplexed. Furthermore, by reading “multicast” used in the above description for “MBMS,” the present invention can be implemented as described above in a mobile communication system in which MBMS data and unicast data are multiplexed.

Further, although a case has been described with the above description where the pilot subcarrier is changed on a per subframe basis, that is, where frequency-hopping of the pilot is performed, the present invention can be implemented as described above even in cases where the pilot subcarriers are made to vary between cells or between sectors without performing frequency-hopping of the pilot.

Furthermore, the subframe used in the above description may employ other transmission time units such as time slots or frames.

Still further, although a case of two cells has been described in the above description as an example, the present invention can be implemented as described above in case of three or more cells.

The CP used in the above description may also be referred to as a “guard interval (GI).” Further, a subcarrier may also be referred to as a “tone.” Furthermore, the base station and mobile station may also be referred to as “Node B” and “UE,” respectively. Still further, the pilot may also be referred to as a “reference signal.”

Also, although cases have been described with the above embodiment as examples where the present invention is configured by hardware, the present invention can also be realized by software.

Each function block employed in the description of the above embodiment may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-127632, filed on May 1, 2006, including the specification, drawings and abstract, is incorporated herein by reference in its entirety.

### INDUSTRIAL APPLICABILITY

The present invention is applicable to, for example, a mobile communication system.

1. A radio communication base station apparatus comprising:
an arranging section that, in a first subframe in which unicast data is arranged and multicast data is not arranged, arranges downlink unicast data control information according to an arrangement pattern that is common between a plurality of cells, and arranges a unicast data pilot according to an arrangement pattern that is different from the common arrangement pattern and that varies between the plurality of cells, and, in a second subframe in which the multicast data is arranged, arranges the multicast data or a multicast data pilot according to a same arrangement pattern as the common arrangement pattern; and
a transmitting section that transmits the downlink unicast data control information and the unicast data pilot arranged in the first subframe and the multicast data or the multicast data pilot arranged in the second subframe.

2. The radio communication base station apparatus according to claim 1, wherein the arranging section changes the arrangement pattern for the unicast data pilot on a per subframe basis.

3. The radio communication base station apparatus according to claim 1, wherein the arranging section makes the common arrangement pattern the same between all subframes.

4. The radio communication base station apparatus according to claim 1, wherein the arranging section arranges the multicast data or the multicast data pilot in the second subframe according to a same arrangement pattern as the common arrangement pattern only in a frequency band in which the multicast data is arranged.

5. A transmitting method in a radio communication base station apparatus that transmits a first subframe in which unicast data is arranged and multicast data is not arranged and a second subframe in which the multicast data is arranged, the transmitting method comprising:
in the first subframe, arranging and transmitting downlink unicast data control information according to an arrangement pattern that is common between a plurality of cells and a unicast data pilot according to an arrangement pattern that is different from the common arrangement pattern and that varies between a plurality of cells; and
in the second subframe, arranging and transmitting the multicast data or a multicast data pilot according to a same arrangement pattern as the common arrangement pattern.
